(19) United States
(12) Patent Application Publication
(10) Pub. No.: US 2013/0268391 A1
(43) Pub. Date: Oct. 10, 2013

(54) SMART GIFT LIST

(71) Applicants: Darrell Esch, San Jose, CA (US); Michael We Chung Wu, Mountain View, CA (US); Yun Flint, Santa Clara, CA (US)

(72) Inventors: Darrell Esch, San Jose, CA (US); Michael We Chung Wu, Mountain View, CA (US); Yun Flint, Santa Clara, CA (US)

(73) Assignee: EBAY, INC., San Jose, CA (US)

(21) Appl. No.: 13/439,225

(22) Filed: Apr. 4, 2012

(51) Int. Cl. G06Q 30/00

(52) U.S. Cl. 705/26.7

(57) ABSTRACT

A service provider communicates, to a user device, a reminder and suggestions to a user for possible gift purchases for a recipient, based on recipient purchase history, restrictions set by the user for the recipient, preferences set by the user for the recipient/gift, the occasion for the gift, and/or other factors. The user can select one or more recommended gifts from the user device and make the purchase through the user device.

### BACKGROUND

1. Field of the Invention

The present invention generally relates to gift lists and more particularly to gift list recommendations.

2. Related Art

Gift buying can be time-consuming, especially if the buyer does not know what to buy for the recipient. Gift registries, such as for baby showers, weddings, bridal showers, and the like, allow a recipient to specify desired gifts. This way, buyers can simply choose from the gift registry, thereby reducing the time and thought needed to determine what gift to purchase.

However, gift registries are not very common and are typically only used for special one-time events, such as ones mentioned above. In addition, gift registries require the recipient to take the time and effort to set up the registry, including selecting gifts for the registry.

Therefore, a need exists for a buyer to more easily purchase gifts for recipients.

### SUMMARY

According to one embodiment, a user or buyer is provided recommendations on gift items for a specific recipient, based on past purchase history of the recipient. In one embodiment, the user creates or updates a gift list that includes names of recipients, recipient identifiers, such as mobile phone number, email, first and last name, etc., along with any desired date information, such as a recipient birthday, anniversary, recipient's family member birthday, such as a child, sibling, or parent, or any other desired gift-giving day. Other more general gift-giving days may also be included for specific recipients, such as Christmas, Valentine's Day, Easter, Hanukah, Chinese New Year, etc. For each recipient, the user may set limits, budgets, or ranges for gifts, either for individual gifts, total gift purchases for the year, etc.

Such a gift list, which can be managed by a service or payment provider, can be used to send reminders to the user when a particular gift-purchasing day or event is coming up. The service provider may also provide recommendations to the user for the specific recipient based on past history of the recipient, such as what the recipient recently purchased and what the recipient has purchased in the past, including types of purchases, costs, stores, etc. The recommendations may be based further on any restrictions or limitations placed by the user for the recipient or wish list. The list may include links/buttons the user can select to quickly and easily purchase the selected gift item.

Thus, the gift list helps the user to remember gift-buying dates with reminders, enables the user to more easily decide on a gift through targeted recommendations for the specific recipient, and easy purchasing through links on the user device.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing a process a user or buyer performs in setting up a smart gift list according to one embodiment;

FIG. 2 is a flowchart showing a process a payment provider performs in determining a gift recommendation based on the list created in FIG. 1, according to one embodiment;

FIG. 3 is a flowchart showing a process a user performs in making a purchase of a gift recommendation from the payment provider, according to one embodiment;

FIG. 4 is block diagram of a networked system suitable for implementing the process described herein according to an embodiment; and

FIG. 5 is a block diagram of a computer system suitable for implementing one or more components in FIG. 4 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to various embodiments, a smart gift list provides a user specific recommendations for gifts targeted for specific recipients, based on past purchases by the recipient and any restrictions set by the user. The recommendations may be sent to a user mobile device a predetermined or other period of time prior to when the gift should be sent or delivered. The user can select one or more of the recommendations, if desired, to make the purchase. This can be accomplished through links or buttons associated with the item(s). For example, the user can tap or otherwise select a button associated with an item to be directed to an app or site where the user can purchase the item, such as with the service provider.

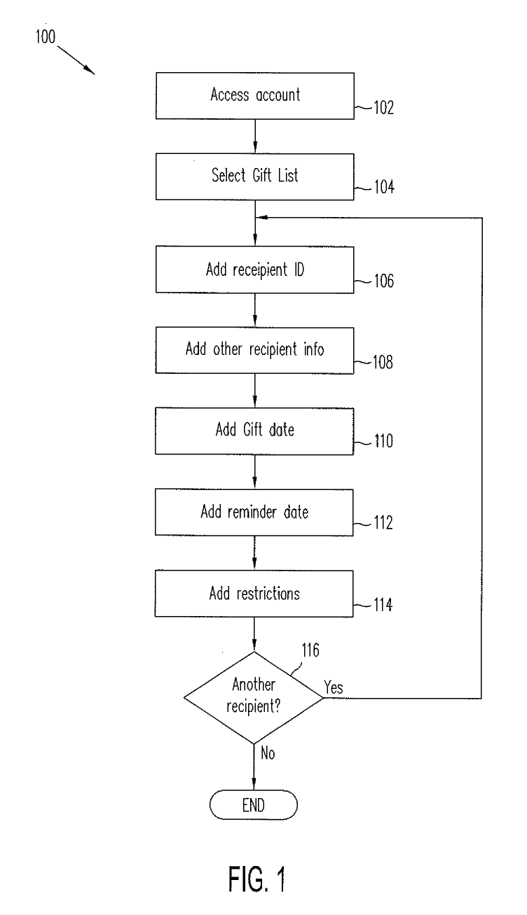

FIG. 1 is a flowchart showing a process 100 a user or buyer performs in setting up a smart gift list according to one embodiment. At step 102, the user access a user account with a service or payment provider, such as PayPal, Inc. of San Jose, Calif. The user may access the account through a computing device, such as a PC, smart phone, tablet, or other suitable device. Accessing may include entering any requested identification and/or authentication information, such as a user name, email address, name, phone number, password, PIN, pass code, etc.

Once the user has been authenticated, the user may be directed to a home page of the payment provider or user account. On the page, there may be an option to access or create a gift list. The option may be presented as a tab, button, or link the user can select. To access this option, the user selects the gift list at step 104, such as by tapping or clicking on the user device through a touch screen or mouse.

The user may then see a screen on the user device having instructions and/or fields for the user to select or enter information into. Examples of requested information include, but are not limited to, a recipient identifier, a gift date, a reminder date, and any restrictions on the gift/recipient, such as price.

At step 106, the user enters a recipient identifier. The identifier can be a name, an email address, a mobile phone number, or other information that identifies the recipient. The type of identifier may be specified by the payment provider in one embodiment. The user may enter the identifier in different ways, including through a user contact or address book on the user device, through a user's social network, manually entering the identifier onto a field through a device keyboard or keypad, or speaking the identifier into a device microphone.

At step 108, the user may have the option of adding additional recipient information. Examples include likes and dislikes of the recipient (which can include types of product, colors, merchants, styles, brands, etc.), age of the recipient, address or location of the recipient, shipping address of the recipient, age of recipient, sex of recipient, size of recipient, marital status of recipient, hobbies of recipient, etc. Such information can be added through voice, text, or any other suitable means.

The user may also be asked to enter a gift date, which can be done at step 110. The gift date can be reason for the gift. For example, a gift date can be specific to the recipient, such as a birthday (of the recipient or a relative, such as child, of the recipient), an anniversary (wedding, work, etc.), a baby shower, a bridal shower, etc., somewhat specific to the recipient, such as secretary's day, and/or general, such as Christmas, Hanukah, Valentine's Day, Easter, Chinese New Year, etc. The date may be one-time or recurring. For the latter, the user may set a recurrence period. Note that more than one date can be selected for the recipient if desired. Date selection can be through a calendar or data entry onto a field on the display of the user device.

At step 112, the user may select a reminder date(s) for the gift date(s) set or added at step 110. For example, the user may want to set earlier reminder dates for Christmas or other gift dates where the user may want more time to shop, purchase, and deliver the gift or want the gift to be delivered before the gift date (again, such as for Christmas or Hanukah). Other dates may have exact delivery dates, such as Valentine's Day. Reminder dates may also be suggested by the payment provider, based on the reason for the gift and previous gift purchases for the same reason.

At step 114, the user may add any restrictions to the gift(s) corresponding to the gift dates selected at step 110. Examples of restrictions include a maximum price, a minimum price, a range of prices, locations of approved or prohibited sellers/merchants, types of approved or prohibited categories of gifts, etc. Price restrictions may be for the specific date/gift, total monthly purchase for the month that includes the gift date, total yearly purchase, or other information.

The user may view the information above at each step and/or when no more information is to be added for the gift and/or recipient to approve or revise any information as desired. Note that one or more of the steps above can be combined with one or more steps, omitted, and/or performed in a different sequence. Once the information is confirmed, the data is stored and associated with the user account and the particular gift date, reminder date, and/or recipient ID.

If the user wishes to add another recipient, the user may repeat the process starting at step 106 by adding an identifier for the next recipient. The process may continue until the user has finished adding recipients.

As such, a gift list can be created with information that enables the payment provider to remind the user of upcoming gift dates and to make suggestions for the user as to what gift(s) to purchase for a specific person, as will be discussed next.

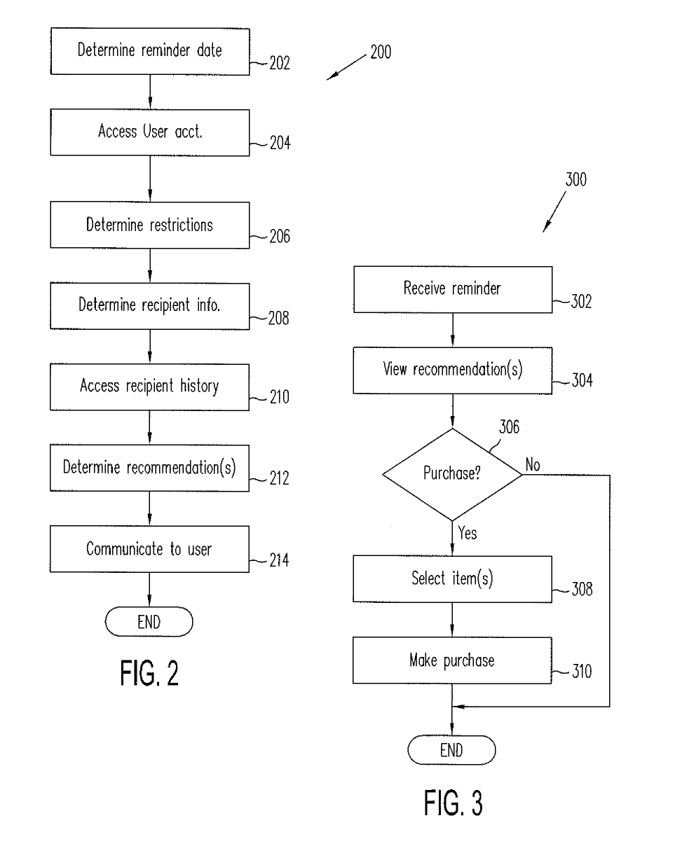

FIG. 2 is a flowchart showing a process 200 a payment provider performs in determining a gift recommendation based on the list created in FIG. 1, according to one embodiment. At step 202, the payment provider determines when a reminder date is approaching For example, the payment provider may be notified at 12:01 a.m. (or other time, such as one day before) of the reminder date for all recipients in the system.

For those user accounts having that reminder date, the payment provider may access those user accounts, at step 204. Once accessed, the payment provider may determine, at step 206, any restrictions for the gift purchase, such as set by the user at step 114 in FIG. 1. The recipient information, such as recipient identifier and recipient preferences/dislikes, may be determined as well, at step 208. With a recipient identifier, the payment provider may then retrieve or otherwise access purchase history by the recipient.

In one embodiment, the recipient identifier allows the payment provider to locate an account with the payment provider associated with the recipient. Once located, the payment provider may access a history of the recipient, at step 210. The history may include details of previous purchases made by the recipient, including when a purchase was made, the amount, the merchant name, the merchant type, the type of item(s) purchased, the location (of the recipient and/or the merchant) for the purchase, purchases shipped to the recipient, purchases shipped to others, etc. The history may further include information about returns by the recipient of purchased items, which may indicate that the recipient likes a general type of item, but not something about a particular returned item.

The history may also include items purchased for or shipped to the recipient by others, such as for gifts, along with the date shipped/received and the same or similar types of information above. In addition to information available through one or more data bases of the payment provider, recipient history may also be obtained from public sources, such as on social networks and other sources on the Internet. Information may include a recipient's likes or dislikes, such as obtained from a social site/network or a shopping site. Thus, even if the recipient does not have an account with the payment provider, the payment provider may be able to obtain recipient history information (both purchases and other types of information) from public sources or databases.

Using the obtained recipient information, gift restrictions, recipient history (e.g., purchase), the payment provider may determine, at step 212, one or more recommendations or suggestions for a gift or gifts for the recipient. For example, if the recipient recently purchased tickets for an upcoming sporting event and the recipient likes dinners at steak houses, the payment provider may suggest a gift certificate for a steak house near the sporting event. In another example, if the recipient recently purchased numerous books about building a shed, the payment provider may suggest some tools needed or useful for building a shed.

In yet another example, if the event is for a baby shower and the recipient recently purchased baby girl clothes and items, the payment provider may suggest items for baby girls (as opposed to baby boys). In a further example, if the recipient has made a lot of purchases from Merchant A, the payment provider may suggest a gift certificate for Merchant A. For another example, if the user recently purchased a tennis racket and balls, the payment provider may suggest one or more tennis accessories. If the gift is for Valentine's Day and the recipient is the wife of the user, the payment provider may suggest something romantic, as opposed to a toaster, even though the recipient recently purchased kitchen items.

The price of the suggestions may be limited by price restrictions set by the user. However, the payment provider may also search and find coupons, sales, or other incentives that can be used during the gift period. If so, the payment provider may suggest an item at a particular merchant using one or more specific discounts or incentives.

Thus, as seen above, using a recipient's history and other information about the recipient, the payment provider can make a “smart” recommendation as to a gift for the recipient.

Once one or more gift recommendations is determined, the recommendation(s) are communicated to the user at step 214. The recommendations may be communicated to the user device, such as through text, email, or a voice message/call. For example, the user may receive a link to access, which directs the user to a site of the payment provider that shows the recommendation(s), along with details, such as description, price, merchant, and any other suitable information. Each recommendation may also be associated with a button, link, or box that enables the user to either purchase or obtain more information about the recommended item. By selecting a desire to purchase, the user may be able to quickly and easily make a purchase through the user device, as discussed below.

FIG. 3 is a flowchart showing a process 300 a user performs in making a purchase of a gift recommendation from the payment provider, according to one embodiment. At step 302, the user receives a reminder. The reminder may be sent by the payment provider to the user device, such as through a text, email, voice call, or voice message. The user may receive the reminder on the date set by the user or on a date set by the payment provider.

The reminder may include information about gift recommendation(s) for the user for a particular recipient, which the user can view at step 304. Depending on how the reminder is delivered or communicated, the user may view the recommendation(s) in different ways. For example, if the reminder is sent by text, the text may include a link the user can select, such as by tapping or clicking, to be directed to a page, site, or location where the recommendations can be viewed. If the reminder is sent by email, the recommendations may be included in the email, either in the body of the email or in an attached document. The recommendations may also be accessible or viewable through a link in the email. If the reminder is sent by voice, the message may include instructions on how to view recommendations, such as by accessing the user's account with the payment provider.

Once the user is able to view the payment provide recommendations, the user may make a determination whether to purchase, at step 306, one or more of the recommendations. If the user does not wish to purchase, the process may end. However, in one embodiment, the user may still be interested in one or more of the recommendations. In that case, the user may be given an option to save all the recommendations or selected ones of the recommendations. For example, the user may select a “save recommendations” button for the former. For the latter, the user may click on or otherwise select desired recommendations and then select a button or link to save the selected recommendations. The user may then be able to retrieve the saved recommendations at a later time, such as through the user's account with the payment provider.

If, as determined, at step 306, the user wishes to purchase one or more of the provided recommendations, the user may next select the desired item(s) at step 308. Selection may be through conventional or known means and depend on various factors, such as the type of user device and the way the items are displayed. For example, the user may simply select or tap a box corresponding to an item to select that item. The user may also select or tap on a desired item directly, where the item may be an icon or described in a link.

Once the desired item(s) have been selected, the user may then purchase the item(s) at step 310. For example, on the user device, the user may select a “Purchase” or “Buy” button or link to initiate the payment process or flow. If not already authenticated or logged in, the user may be asked to enter certain information, such as a user name, an email address, and/or a password/PIN. If partially authenticated, the user may only need to enter a password/PIN.

After a successful login or authentication, the user may be shown a checkout page for purchasing the selected item(s). In one embodiment, the checkout page is at a merchant site offering the selected item. In another embodiment, the checkout page may include all items in a single cart from different merchants, such as page hosted by the payment provider.

A checkout page may include fields, either to be filled in or pre-filled, such as shipping address, billing address, funding source information, etc. In one embodiment, because the payment provider knows information about the intended recipient of the item(s) or gift(s) as well as the user, the shipping information may be automatically populated. The user may have the option of shipping the items to the user or directly to the recipient. Once all the requested fields have been completed, the payment may be processed by the payment provider, such as debiting an account of the user and crediting an account of one or more sellers/merchants. A notification may be sent to the merchant and/or user of a successful payment.

Thus, a user can quickly and easily make a gift purchase through customized recommendations by the payment provider.

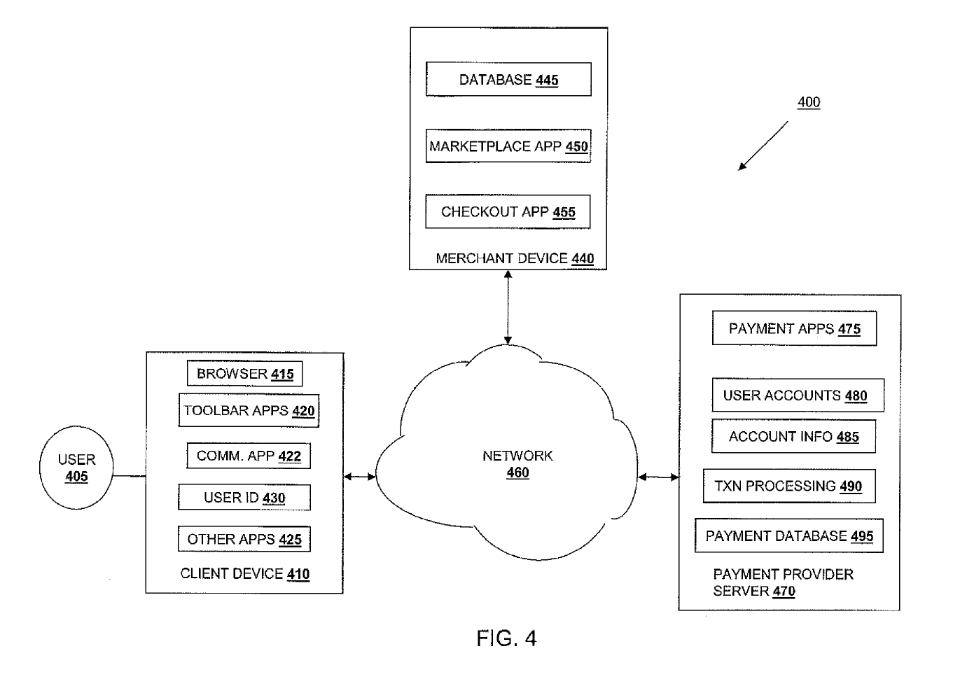

FIG. 4 is a block diagram of a networked system 400 configured to handle a transaction using a smart wallet, such as described above, in accordance with an embodiment of the invention. System 400 includes a user device 410, a merchant server 440, and a payment provider server 470 in communication over a network 460. Payment provider server 470 may be maintained by a payment provider, such as PayPal, Inc. of San Jose, Calif. A user 405, such as a sender or consumer, utilizes user device 410 to perform a transaction using payment provider server 470. Note that transaction, as used herein, refers to any suitable action performed using the user device, including payments, transfer of information, display of information, etc. Although only one merchant server is shown, a plurality of merchant servers may be utilized if the user is purchasing gifts from multiple merchants.

User device 410, merchant server 440, and payment provider server 470 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

Network 460 may be implemented as a single network or a combination of multiple networks. For example, in various embodiments, network 460 may include the Internet or one or more intranets, landline networks, wireless networks, and/or other appropriate types of networks.

User device 410 may be implemented using any appropriate hardware and software configured for wired and/or wireless communication over network 460. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 410 may include one or more browser applications 415 which may be used, for example, to provide a convenient interface to permit user 405 to browse information available over network 460. For example, in one embodiment, browser application 415 may be implemented as a web browser configured to view information available over the Internet, such as a user account for setting up a gift list and/or merchant sites for viewing and purchasing gifts. User device 410 may also include one or more toolbar applications 420 which may be used, for example, to provide client-side processing for performing desired tasks in response to operations selected by user 405. In one embodiment, toolbar application 420 may display a user interface in connection with browser application 415 as further described herein.

User device 410 may further include other applications 425 as may be desired in particular embodiments to provide desired features to user device 410. For example, other applications 425 may include security applications for implementing client-side security features, programmatic client applications for interfacing with appropriate application programming interfaces (APIs) over network 460, or other types of applications. Applications 425 may also include email, texting, voice and IM applications that allow user 405 to send and receive emails, calls, and texts through network 460, as well as applications that enable the user to communicate, transfer information, make payments, and otherwise utilize a smart wallet through the payment provider as discussed above. User device 410 includes one or more user identifiers 430 which may be implemented, for example, as operating system registry entries, cookies associated with browser application 415, identifiers associated with hardware of user device 410, or other appropriate identifiers, such as used for payment/user/device authentication. In one embodiment, user identifier 430 may be used by a payment service provider to associate user 405 with a particular account maintained by the payment provider as further described herein. A communications application 422, with associated interfaces, enables user device 410 to communicate within system 400.

Merchant server 440 may be maintained, for example, by a merchant or seller offering various products and/or services in exchange for payment to be received over network 460. Merchant server 440 may be used for POS or online purchases and transactions. Generally, merchant server 440 may be maintained by anyone or any entity that receives money, which includes charities as well as retailers and restaurants. For example, a recommended gift may be a donation to charity in the name of the recipient. Merchant server 440 includes a database 445 identifying available products and/or services (e.g., collectively referred to as items) which may be made available for viewing and purchase by user 405. Accordingly, merchant server 440 also includes a marketplace application 450 which may be configured to serve information over network 460 to browser 415 of user device 410. In one embodiment, user 405 may interact with marketplace application 450 through browser applications over network 460 in order to view various products, food items, or services identified in database 445.

Merchant server 440 also includes a checkout application 455 which may be configured to facilitate the purchase by user 405 of goods or services identified by marketplace application 450. Checkout application 455 may be configured to accept payment information from or on behalf of user 405 through payment service provider server 470 over network 460. For example, checkout application 455 may receive and process a payment confirmation from payment service provider server 470, as well as transmit transaction information to the payment provider and receive information from the payment provider (e.g., a transaction ID).

Payment provider server 470 may be maintained, for example, by an online payment service provider which may provide payment between user 405 and the operator of merchant server 440. In this regard, payment provider server 470 includes one or more payment applications 475 which may be configured to interact with user device 410 and/or merchant server 440 over network 460 to facilitate the purchase of goods or services, communicate/display information, and send payments by user 405 of user device 410 and as discussed above.

Payment provider server 470 also maintains a plurality of user accounts 480, each of which may include account information 485 associated with individual users, including gift recipients. For example, account information 485 may include private financial information of users of devices such as account numbers, passwords, device identifiers, user names, phone numbers, credit card information, bank information, or other financial information which may be used to facilitate online transactions by user 405. Account information may also include user purchase history, which may include search history, as well as gift list information discussed herein. Advantageously, payment application 475 may be configured to interact with merchant server 440 on behalf of user 405 during a transaction with checkout application 455 to track and manage purchases made by users and which funding sources are used, as well as incentives for a user.

A transaction processing application 490, which may be part of payment application 475 or separate, may be configured to receive information from a user device and/or merchant server 440 for processing and storage in a payment database 495. Transaction processing application 490 may include one or more applications to process information from user 405 for processing an order and payment using various selected funding instruments as described herein. As such, transaction processing application 490 may store details of an order associated with a phrase from individual users. Payment application 475 may be further configured to determine the existence of and to manage accounts for user 405, as well as create new accounts if necessary, such as the set up, management, and use of “smart” gift lists for users as discussed herein.

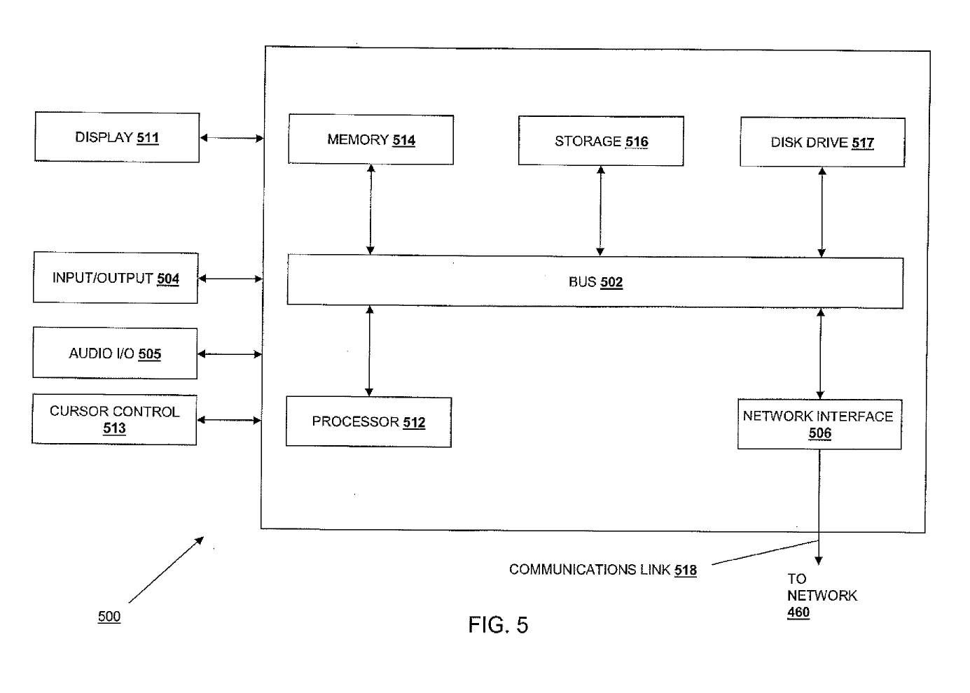

FIG. 5 is a block diagram of a computer system 500 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 500 in a manner as follows.

Computer system 500 includes a bus 502 or other communication mechanism for communicating information data, signals, and information between various components of computer system 500. Components include an input/output (1/0) component 504 that processes a user action, such as selecting keys from a keypad/keyboard, selecting one or more buttons or links, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a payment provider server via network 360. In one embodiment, the transmission is wireless, although other transmission mediums and methods may also be suitable. A processor 512, which can be a micro-controller, digital signal processor (DSP), or other processing component, processes these various signals, such as for display on computer system 500 or transmission to other devices via a communication link 518. Processor 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor 512 and other components by executing one or more sequences of instructions contained in system memory component 514. Logic may be encoded in a computer readable medium, which may refer to any medium that participates in providing instructions to processor 512 for execution. Such a medium may take many forms, including but not limited to, non-volatile media, volatile media, and transmission media. In various implementations, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing account information for a plurality of users, wherein the account information comprises information about a user-created gift list, the gift list comprising recipient information and gift dates, and information about recipient purchase history;
a processor operable to:
determine an upcoming gift date for a recipient based on the information about the user-created gift list;
determine any user imposed restrictions for the recipient based on the information about the user-created gift list;
determine one or more gift suggestions for the recipient based on at least purchase history by the recipient and any user imposed restrictions; and
communicate the one or more gift suggestions to a user on a user device.

2. The system of claim 1, wherein the upcoming gift date is based on a reminder date set by the user.

3. The system of claim 1, wherein the gift list is created by the user through a third party service provider.

4. The system of claim 1, wherein the user imposed restrictions comprise an amount limit.

5. The system of claim 2, wherein the one or more gift suggestions is communicated on the reminder date.

6. The system of claim 1, wherein the user device is a smart phone.

7. The system of claim 1, wherein the one or more gift suggestions are further determined based on any user-set preferences for the recipient.

8. The system of claim 1, wherein the purchase history comprises types of items purchased, dates of purchase, amounts of purchase, merchant items purchased from, and locations of purchase.

9. The system of claim 1, wherein the processor is further configured to receive a user selection from the one or more gift suggestions and to process a payment for the user selection.

10. A method for performing a transaction using a user device, comprising:
determining, by a processor of a service provider, an upcoming gift date for a recipient based on the information about the user-created gift list;
determining, by the processor, any user imposed restrictions for the recipient based on the information about the user-created gift list;
determining, by the processor, one or more gift suggestions for the recipient based on at least purchase history by the recipient and any user imposed restrictions; and
communicating, electronically, the one or more gift suggestions to a user on a user device.

11. The method of claim 10, wherein the upcoming gift date is based on a reminder date set by the user.

12. The method of claim 10, wherein the user imposed restrictions comprise an amount limit.

13. The method of claim 11, wherein the one or more gift suggestions is communicated on the reminder date.

14. The method of claim 10, wherein the one or more gift suggestions are further determined based on any user-set preferences for the recipient.

15. The method of claim 10, wherein the purchase history comprises types of items purchased, dates of purchase, amounts of purchase, merchant items purchased from, and locations of purchase.

16. The method of claim 10, further comprising receiving a user selection from the one or more gift suggestions and processing a payment for the user selection.

17. A non-transitory machine-readable medium comprising a plurality of machine-readable instructions which when executed by one or more processors of a server are adapted to cause the server to perform a method comprising:
determining, by a service provider, an upcoming gift date for a recipient based on the information about the user-created gift list;
determining any user imposed restrictions for the recipient based on the information about the user-created gift list;
determining one or more gift suggestions for the recipient based on at least purchase history by the recipient and any user imposed restrictions; and
communicating the one or more gift suggestions to a user on a user device.

18. The non-transitory machine-readable medium of claim 17, wherein the upcoming gift date is based on a reminder date set by the user.

19. The non-transitory machine-readable medium of claim 17, wherein the user imposed restrictions comprise an amount limit.

20. The non-transitory machine-readable medium of claim 18, wherein the one or more gift suggestions is communicated on the reminder date.

21. The non-transitory machine-readable medium of claim 17, wherein the one or more gift suggestions are further determined based on any user-set preferences for the recipient.

22. The non-transitory machine-readable medium of claim 17, wherein the purchase history comprises types of items purchased, dates of purchase, amounts of purchase, merchant items purchased from, and locations of purchase.

23. The non-transitory machine-readable medium of claim 17, wherein the method further comprises receiving a user selection from the one or more gift suggestions and processing a payment for the user selection.
